(19) United States
(12) Patent Application Publication
(10) Pub. No.: US 2016/0363686 A1
(43) Pub. Date: Dec. 15, 2016

(54) ANTENNA STRUCTURES AND APPARATUS FOR DIELECTRIC LOGGING

(71) Applicant: BAKER HUGHES INCORPORATED, Houston, TX (US)

(72) Inventors: BABAK KOUCHMESHKY, Kingwood, TX (US); OTTO N. FANINI, Houston, TX (US); STANISLAV W. FORGANG, Houston, TX (US)

(73) Assignee: BAKER HUGHES INCORPORATED, Houston, TX (US)

(21) Appl. No.: 14/738,224

(22) Filed: Jun. 12, 2015

(51) Int. Cl. G01V 3/38; G01V 3/30; H01Q 11/10

(52) U.S. Cl. CPC G01V 3/38; H01Q 11/10; G01V 3/30

(57) ABSTRACT

This disclosure describes a dielectric logging tool for evaluating the earth formation using at least one transmitter antenna disposed in a cavity on a pad engaged with a borehole wall. The logging tool may comprise at least one power driver in electrical communication with the at least one transmitter antenna and configured to modulate a phase of output current of the at least one power driver. The logging tool may enforce symmetric current on both feeds of the at least one transmitter antenna causing a point of symmetry of the current to align with an axis of geometric symmetry of the at least one transmitter antenna. A parameter of interest of the formation may be estimated by using the attenuation and phase difference between the received and transmitted signals or between received signals from spaced receivers.

### FIELD OF THE DISCLOSURE

This disclosure generally relates to exploration for hydrocarbons involving electrical investigations of a borehole penetrating an earth formation. More specifically, this disclosure relates to a novel antenna and circuitry for estimating a parameter of interest of the earth formation.

### BACKGROUND OF THE DISCLOSURE

Electrical earth borehole logging is well known and various devices and various techniques have been described for this purpose. The dielectric constant of the formation may be estimated by transmitting an electromagnetic (EM) wave into the formation, and receiving it at receiver antennas. Then, the attenuation and phase shift between the received signals and the transmitted signals are determined, which are used to estimate the dielectric constant of the formation. Alternatively, the attenuation and phase shift between spaced receivers may be used to estimate the dielectric constant of the formation.

### SUMMARY OF THE DISCLOSURE

In aspects, the present disclosure is related to methods and apparatuses for estimating at least one parameter of interest using at least one transmitter antenna, and at least one power driver in electrical communication with the at least one transmitter antenna and configured to modulate a phase of output current of the at least one driver.

One embodiment according to the present disclosure includes a an apparatus for evaluating an earth formation, the apparatus comprising: a carrier configured for conveyance in a borehole intersecting the earth formation; a logging tool disposed on the carrier, the logging tool comprising: a pad having at least one face configured to engage the borehole wall, the face comprising a surface defining a cavity, at least one transmitter antenna disposed in the cavity of the face, the at least one transmitter antenna receiving an electrical signal from an excitation source, and at least one power driver in electrical communication with the at least one transmitter antenna and configured to modulate a phase of output current of the at least one driver.

The electrical signals applied to the at least one transmitter antenna via the at least one power driver enforce symmetric current on both feeds of the transmitter antenna causing a point of symmetry of the current to align with an axis of geometric symmetry of the at least one transmitter antenna. The at least one transmitter antenna includes at least one feed. The at least one power driver may be in electrical communication with the at least one transmitter antenna through at least one feed.

The at least one transmitter antenna may comprise a tri-axial antenna. The at least one transmitter antenna may comprise a feed for each axis; each feed is in electrical communication with the at least one power driver; and the excitation source is in electrical communication with the at least one power driver. The at least one transmitter antenna may comprise a logarithmic periodic antenna having a bandwidth covering the frequency range from about 2 MHz to about 1 GHz. The at least one transmitter antenna may be disposed on the pad between the cavity and the earth formation, when and where the face is engaged with the borehole wall. The cavity may comprise a concave cavity configured to focus an electromagnetic wave into the earth formation. The surface defining the cavity may comprise at least one layer of a functionally gradient material on top of a metal material. The functionally gradient material may comprise at least one: (i) a dielectric material and (ii) a ferromagnetic material. The at least one power driver may have balanced differential outputs in electrical communication with the at least one transmitter antenna. The at least one power driver may electrically float with respect to the pad. The logging tool may comprise a second cavity on the pad with a receiver antenna disposed in the second cavity; the apparatus may comprise at least one processor configured to estimate a parameter of interest of the earth formation using signals received by the at least one receiver antenna. The parameter of interest may include one of (i) a water saturation of the formation, (ii) a water conductivity of the formation, (iii) a complex permittivity of the formation, (iv) a permittivity of rock matrix, (v) a complex permittivity of mudcake, (vi) a thickness of the mudcake, (vii) a texture of the rock, (viii) cementation exponent, (ix) saturation exponent, and (x) cation exchange capacity.

Another embodiment of the present disclosure includes a method for evaluating an earth formation, the method comprising: actively changing an impedance of at least one transmitter antenna disposed on a logging tool, using at least one power driver in electrical communication with the at least one transmitter antenna and configured to modulate a phase of an output current applied to the at least one transmitter antenna. The method may further comprise: conveying the at least one transmitter in a borehole intersecting the earth formation, wherein the at least one transmitter antenna comprises a tri-axial antenna; applying an output current to the at least one transmitter antenna using the at least one power driver; enforcing symmetric current on both ends of the at least one transmitter causing a point of symmetry of the current to align with an axis of geometric symmetry of the at least one transmitter; receiving signals using at least one receiver antenna; and estimating a parameter of interest of the earth formation using the received signals.

Examples of the more important features of the disclosure have been summarized rather broadly in order that the detailed description thereof that follows may be better understood and in order that the contributions they represent to the art may be appreciated.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1 shows a schematic of a borehole including a downhole tool for estimating a parameter of interest of an earth formation according to embodiments of the present disclosure;

FIG. 2 shows a cross-sectional view of a single-ended antenna used to obtain the relative magnitude and phase in FIGS. 6 and 7;

FIG. 3A shows a cross-sectional view of an antenna assembly in accordance with embodiments of the present disclosure;

FIG. 3B shows a tri-axial antenna assembly in accordance with embodiments of the present disclosure;

FIG. 4A shows a schematic of a downhole tool with an antenna disposed in a cavity in accordance with embodiments of the present disclosure;

FIG. 4B shows a schematic of a pad on the downhole tool with an antenna disposed in a cavity in accordance with embodiments of the present disclosure;

FIG. 5 shows a cross-sectional view of an antenna assembly in accordance with embodiments of the present disclosure;

FIG. 6 shows a chart of the relative magnitude versus frequency for an embodiment of the present disclosure;

FIG. 7 shows a chart of the relative phase versus frequency for an embodiment of the present disclosure;

FIG. 8 shows a chart of permittivity of water versus frequency used to obtain the relative magnitude and phase in FIGS. 10 and 11;

FIG. 9 shows a chart of the conductivity of water versus frequency used to obtain the relative magnitude and phase in FIGS. 10 and 11;

FIG. 10 shows a chart of the relative magnitude versus frequency for an embodiment of the present disclosure in a water tank;

FIG. 11 shows a chart of the relative phase versus frequency for an embodiment of the present disclosure in a water tank;

FIG. 12 shows a cross-sectional view of an antenna assembly in accordance with embodiments of the present disclosure;

FIG. 13 shows a cross-sectional view of an antenna assembly in accordance with embodiments of the present disclosure;

FIG. 14 shows a cross-sectional view of an antenna assembly in accordance with embodiments of the present disclosure;

FIG. 15 shows a cross-sectional view of an antenna assembly in accordance with embodiments of the present disclosure;

FIG. 16A shows a cross-sectional view of an antenna assembly in accordance with embodiments of the present disclosure;

FIG. 16B shows a cross-sectional view of radiation patterns of an antenna assembly in accordance with embodiments of the present disclosure;

FIG. 16C shows a cross-sectional view of radiation patterns of an antenna assembly in accordance with embodiments of the present disclosure;

FIG. 17 shows a schematic of the downhole tool in accordance with embodiments of the present disclosure;

FIG. 18 shows a schematic of the downhole tool in accordance with embodiments of the present disclosure; and

FIG. 19 shows a flow chart of a method for estimating at least one parameter of interest according to embodiments of the present disclosure.

### DETAILED DESCRIPTION

This disclosure generally relates to exploration for hydrocarbons involving electromagnetic investigations of a borehole penetrating an earth formation. These investigations may include estimating at least one parameter of interest of the earth formation.

The present disclosure is susceptible to embodiments of different forms. There are shown in the drawings, and herein will be described in detail, specific embodiments of the present disclosure with the understanding that the present disclosure is to be considered an exemplification of the principles of the disclosure, and is not intended to limit the disclosure to that illustrated and described herein. Indeed, as will become apparent, the teachings of the present disclosure can be utilized for a variety of well tools and in all phases of well construction and production. Accordingly, the embodiments discussed below are merely illustrative of the applications of the present disclosure.

The complex permittivity of the earth formation may be estimated using a well logging system. Electromagnetic waves are energized in the formation using a transmitter antenna disposed in the borehole. The attenuation and phase difference between signals received by spaced receiver antennas disposed in the borehole may be used to estimate the complex permittivity, which may be used to estimate a water saturation of the formation. To increase the accuracy of these estimations, the transmitter and receiver antennas may be configured to operate across a wide frequency band, e.g. from 2 MHz to 1 GHz, and approximate the performance of an ideal magnetic dipole (i.e. infinitesimal dipole).

As an example, the transmitter antenna may be configured as a single-ended antenna inside a cavity of a body conveyed in the borehole. The body may be urged against the borehole so that it engages the borehole wall to measure properties of the borehole or formation using the single-ended transmitter antenna. The single-ended antenna may include a looped wire having a single feed to an excitation source. From this feed, the wire completes a loop by grounding itself to the surface of the cavity. The excitation source energizes the looped wire by applying an alternating current across a wide bandwidth of frequencies.

Ideally, the current travels along the cavity to match a magnetic dipole's current path, e.g. a perfect loop that begins from the feed, runs along the looped wire, and returns to the feed along the cavity's conductive surface. In practice, the single-ended antenna does not represent a perfect magnetic dipole over a wide frequency band due to asymmetry in its current path. To align the asymmetric current with a symmetric axis of the antenna's dimensions, a power source may be configured to apply a phase-shifted current on a second feed of the antenna transmitter. This second feed may be at the point where the single-ended antenna would be grounded to the cavity. This phase-shifted current applied at the second feed enforces a uniform current across the radiating extent of the antenna.

Using a logarithmic periodic (log-periodic) antenna on a body conveyed on a carrier may provide superior performance over a wide frequency band in estimating a complex permittivity of the formation. The antenna may be driven by antenna drivers that are configured to actively change the impedance of the antenna over this wide frequency band.

The antenna may be used for measuring anisotropic behavior of the formation (e.g., anisotropic complex permittivity) by having radiating elements along three axes (e.g., a tri-axial antenna). Each axial radiating element of the tri-axial antenna may provide anisotropic properties of the formation. The tri-axial antenna may be disposed in a concave cavity to enhance the performance of the antenna (e.g., gain), providing an improved depth of investigation into the formation by the electromagnetic waves. In other embodiments, the concave cavity may comprise layers of varying functionally gradient materials and metal materials. This allows the surface impedance of the concave cavity to be configured as an EM reflector to improve the performance of the antenna at different frequencies (e.g., configuring the current distribution to direct the radiation pattern). The power source that energizes the tri-axial antenna may be coupled to an isolated ground to reduce the effects of noise from a common power source or ground on the carrier.

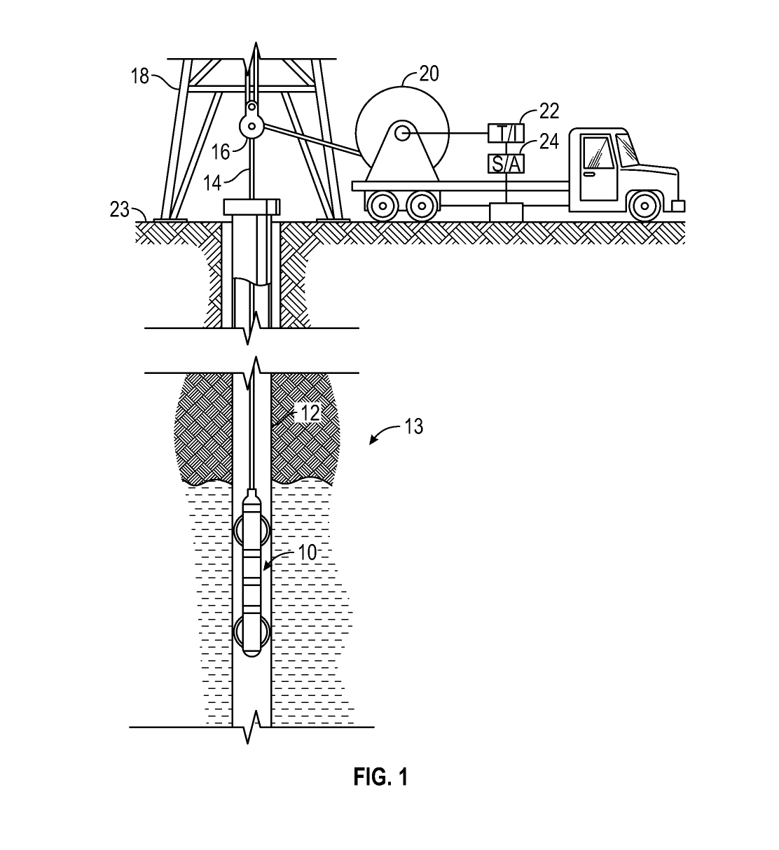

FIG. 1 shows a downhole tool (logging tool, electromagnetic tool, dielectric tool, or tool) 10 suspended in a borehole 12 penetrating earth formation 13 from a suitable cable 14 that passes over a sheave 16 mounted on drilling rig 18. The downhole tool 10 is raised and lowered by draw works 20. Electronic module 22, on the surface 23, transmits the required operating commands downhole and in return, receives data back which may be recorded on an archival storage medium of any desired type for concurrent or later processing. The data may be transmitted in analog or digital form. Information analysis may be performed in the field in real time using one or more processors, such as a suitable computer 24, the recorded information may be sent to a processing center, or both. Some or all of the processing may also be done by using a downhole processor at a suitable location on the tool 10. While a wireline conveyance system has been shown, it should be understood that embodiments of the present disclosure may be utilized in connection with tools conveyed via carrier, which may be rigid carriers (e.g., jointed tubular or coiled tubing) or non-rigid carriers (e.g., wireline, slickline, e-line, etc.). Some embodiments of the present disclosure may be deployed along with logging-while-drilling (LWD) tools or measurements-while-drilling (MWD) tools. The downhole tool 10 may be included in or embodied as a bottomhole assembly (BHA), drillstring component or other suitable carrier. A “carrier” as described herein means any device, device component, combination of devices, media and/or member that may be used to convey, house, support or otherwise facilitate the use of another device, device component, combination of devices, media and/or member. Exemplary non-limiting carriers include drill strings of the coiled tubing type, of the jointed pipe type and any combination or portion thereof. Other carriers include, but are not limited to, casing pipes, wirelines, wireline sondes, slickline sondes, drop shots, downhole subs, bottom-hole assemblies, and drill strings.

As described herein, “borehole” or “wellbore” refers to a single hole that makes up all or part of a drilled well. As described herein, “formations” refer to the various features and materials that may be encountered in a subsurface environment and surround the borehole. The term “information” includes, but is not limited to, raw data, processed data, and signals.

In one embodiment, the downhole tool 10, may include sensor devices configured to measure various parameters of the formation and/or borehole. For example, one or more parameter sensors are configured for formation evaluation measurements and/or other parameters of interest (referred to herein as “evaluation parameters”) relating to the formation, borehole, geophysical characteristics, borehole fluids and boundary conditions. These sensors may include formation evaluation sensors (e.g., resistivity, dielectric constant, water saturation, porosity, density and permeability), sensors for measuring borehole parameters (e.g., borehole size, borehole inclination and azimuth, and borehole roughness), sensors for measuring geophysical parameters (e.g., acoustic velocity, acoustic travel time, electrical resistivity), sensors for measuring borehole fluid parameters (e.g., viscosity, density, clarity, rheology, pH level, and gas, oil and water contents), boundary condition sensors, and sensors for measuring physical and chemical properties of the borehole fluid.

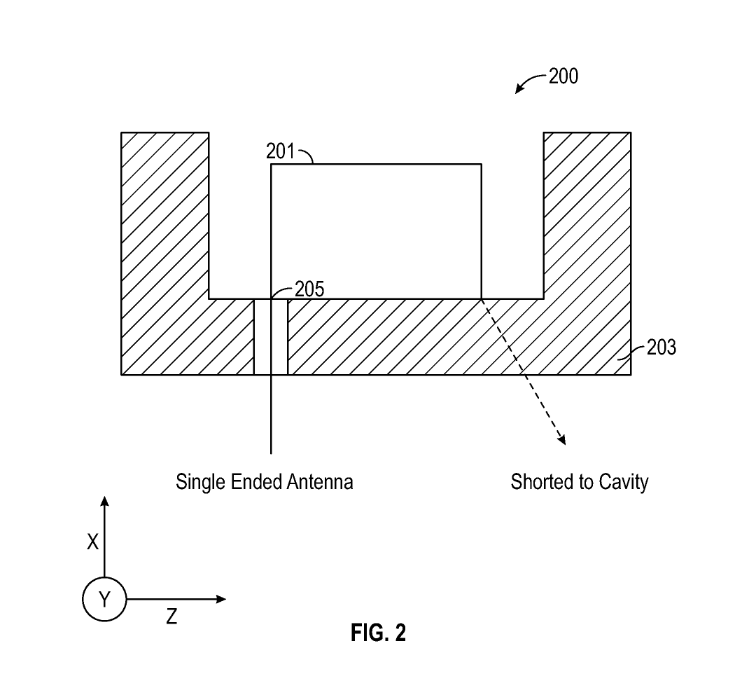

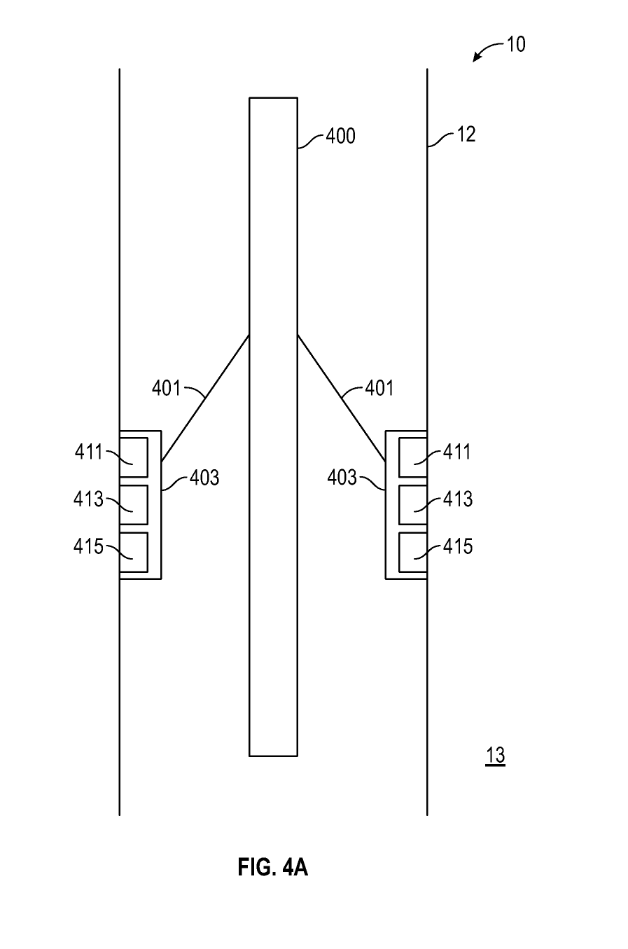

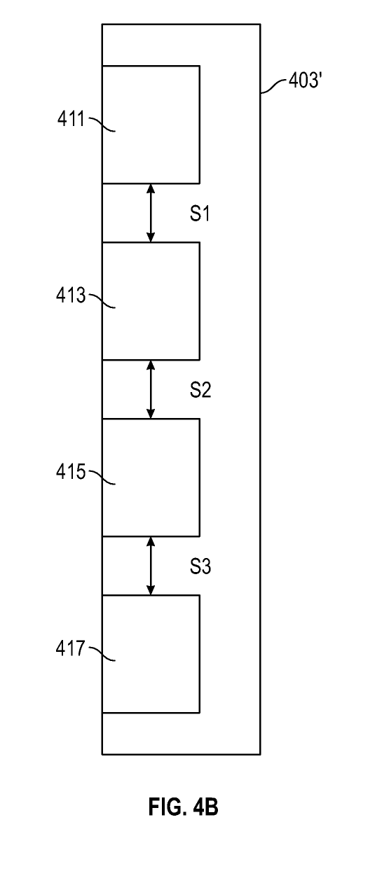

FIG. 2 depicts single-ended antenna 200 that includes a wire loop (loop antenna) 201 disposed in cavity 203, which may be defined by a body (e.g., 400 of FIG. 4A) or a pad (e.g. 403 of FIGS. 4A and 4B). The loop antenna 201 is grounded to cavity 203 to provide a current path substantially similar to a magnetic dipole. The loop antenna 201 has a single feed 205 to an excitation source (not shown). As discussed above, the singe-ended antenna 200 may only roughly approximate the performance of a perfect magnetic dipole over a wide frequency band due to asymmetry in its current path.

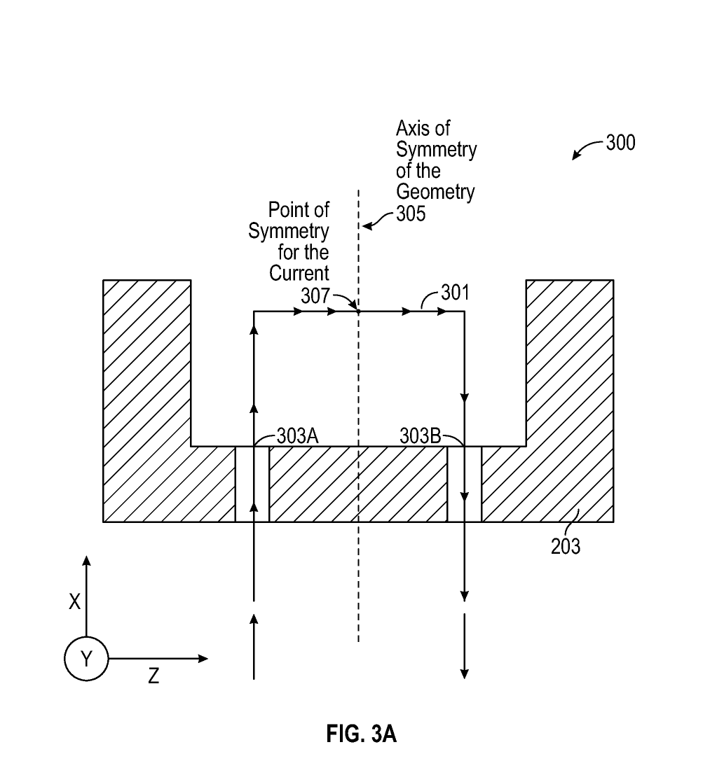

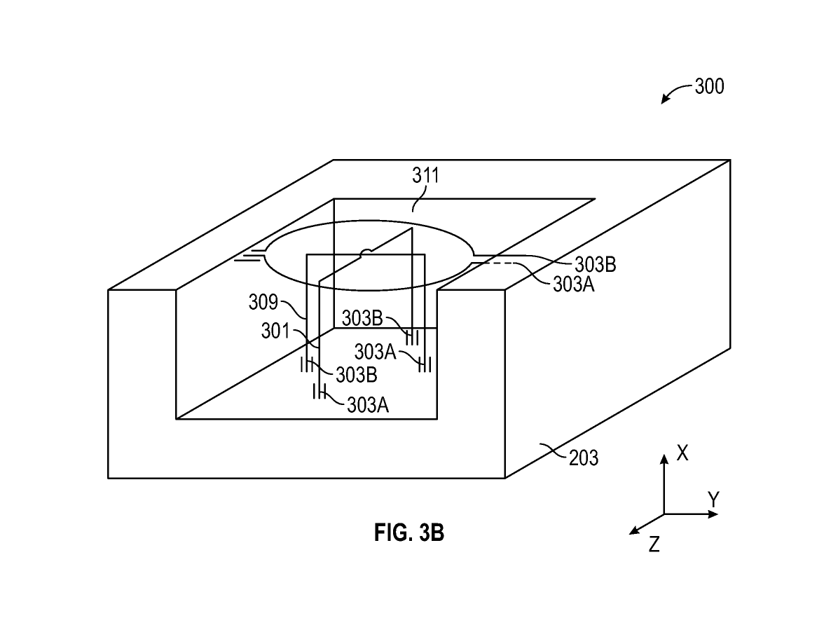

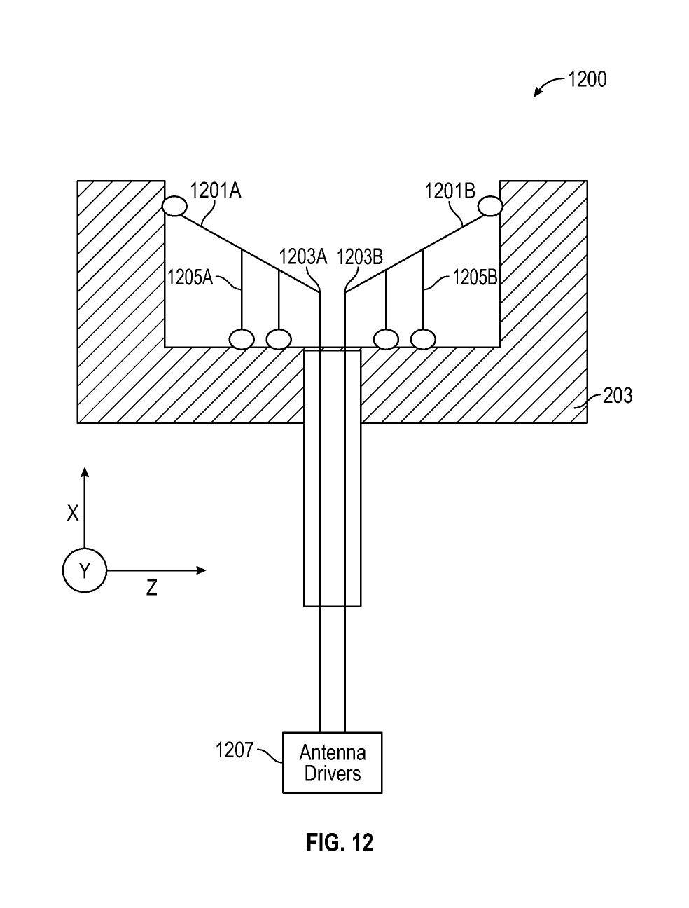

FIG. 3A shows a cross-sectional view of an antenna assembly 300 in accordance with embodiments of the present disclosure. This cross-section is representative of the antenna assembly having a magnetic moment parallel to the y-axis, where the y-axis is orthogonal to the X-Z plane depicted by the reference axes. An approximate current path of loop antenna 301 is depicted using the arrows along the loop when loop antenna 301 is in electrical communication with antenna drivers (e.g. 1207 of FIG. 12) via feeds 303A, 303B. The antenna drivers align the asymmetric current to the antenna's axis of geometric symmetry 305 to provide a point of symmetry for the current 307. Absent the antenna drivers, the current path along antenna loop 301 will become asymmetric with relation to the geometry of the antenna. As a consequence, the current magnitude and phase would not be uniform over the extent of antenna loop 301 similar to the situation if the antenna was single-ended as depicted in FIG. 2. To align the asymmetric current with symmetric axis 305 of the antenna's geometry (or dimensions), antenna drivers (e.g. 1207 of FIG. 12) may be configured to apply a phase-shifted current on at least one feed of the antenna transmitter (e.g. feed 303B of loop antenna 301).

FIG. 3B shows antenna assembly 300 configured as a tri-axial antenna. Antenna assembly 300 includes orthogonal loop antennas 301, 309, and 311 disposed in cavity 203. Each loop antenna (301, 309, 311) is configured to be orthogonal to each other loop antenna. Loop antenna 301 is positioned so that its magnetic moment is parallel to the y-axis, i.e. loop antenna 301 has a magnetic moment oriented along the y-axis. Loop antenna 309 has a magnetic moment oriented along the z-axis; and loop antenna 311 has a magnetic moment oriented along the x-axis. Each of these antennas has two feeds 303A, 303B in electrical communication with antenna drivers (e.g. 1207 of FIG. 12). The antenna drivers may apply a phase-shifted current on at least one feed of the tri-axial antenna transmitter to enforce a symmetric current across the radiating extent of the antenna. In other embodiments, each orthogonal antenna 301, 309, 311 representing a magnetic dipole along the x-axis, y-axis, and z-axis may be disposed in separate cavities (e.g. cavities of antenna assemblies 413, 415, 417 of FIG. 4B). As another example, two orthogonal antennas (e.g. antennas oriented along y-axis and z-axis) may be disposed in one cavity, while a third orthogonal antenna (e.g. an antenna oriented along x-axis) may be disposed in a separate cavity. In other embodiments, antenna assembly 300 may include a multi-axial antenna comprising one or more antennas oriented along the x-axis, y-axis, and z-axis or one or more antennas oriented by a displaced angle from these axes, e.g. 45 degrees.

Aspects of the present disclosure as described above may be incorporated in various different embodiments. For example, a tri-axial antenna may be disposed in a cavity on dielectric tool 10 to estimate a parameter of interest of the earth formation. The antenna may be in electrical communication with antenna drivers configured to enforce a symmetric current on both feeds of the antenna by shifting the phase of an output current from one of the antenna drivers.

FIGS. 4A and 4B show dielectric tool (downhole tool, logging tool, dielectric logging tool, electromagnetic tool, or tool) 10 for evaluating an earth formation according to embodiments of the present disclosure. The dielectric tool 10 may be disposed on a carrier (not shown) intersecting the earth formation 13. The dielectric tool 10 may include a body (dielectric tool body) 400 having pads 403 extended on extension devices 401. Two pads are shown for illustrative purposes and, in actual practice, there may be more or fewer pads, such as three pads separated by about 120 degrees circumferentially or six pads separated by about 60 degrees. The extension devices 401 may be electrically operated, electromechanically operated, mechanically operated or hydraulically operated. With the extension devices 401 fully extended, the pads (dielectric tool pads) 403 may engage the borehole 12 and make measurements indicative of at least one parameter of interest of the earth formation, such as (i) a water saturation of the formation, (ii) a water conductivity of the formation, (iii) a complex permittivity of the formation, (iv) a permittivity of rock matrix, (v) a complex permittivity of mudcake, (vi) a thickness of the mudcake, (vii) a texture of the rock, (viii) cementation exponent, (ix) saturation exponent, and (x) cation exchange capacity.

Pads 403 may include a face configured to engage the borehole 12. The term “engage,” as used herein, may be defined as in contact with the borehole 12, urged against the borehole 12, pressed firmly against the borehole 12, or positioned proximate the borehole 12. The term “proximate,” as used herein, may be defined as the pad being near the borehole 12 such that measurements may be taken from the pad that are useful in evaluating the borehole, earth formation, or both. The term “face” refers to the surface, edge, or side of the tool body or pad that is closest to the borehole wall.

Pads 403 may include antenna assemblies 411, 413, and 415. The antenna assemblies 411, 413, and 415 may be configured to transmit electromagnetic (EM) waves, receive EM waves, or both transmit and receive EM waves. The antenna assemblies 411, 413, and 415 each include a cavity (e.g. 203 of FIGS. 2, 3A, and 3B) defined by a surface and an antenna (not shown) disposed in the cavity. Pads 403 may operate as a ground plane against the antenna included in the antenna assemblies. Antenna assemblies 411, 413, and 415 may be used to estimate the parameter of interest of the earth formation.

For example, antenna assembly 411 may be configured to radiate EM waves into the formation using antenna drivers (e.g. 1207), which will be described in more detail according to FIG. 12. Then, antenna assemblies 413 and 415 may be configured to receive the EM waves radiating in the formation and generate a signal that is indicative of the parameter of interest (e.g. water saturation, water conductivity, or complex permittivity of the formation). In this example, the transmitter-receiver pattern may be indicated as T-R-R, where R indicates a receiver and T indicates a transmitter, going from top to bottom of pad 403. A processor may be configured to estimate the amplitude attenuation and phase difference between the transmitted signal and the received signals, which are used to estimate the parameter of interest. As an example, the attenuation and phase difference may be estimated between the received signals from spaced antenna assemblies (e.g., 413 and 415). This processing may be done downhole or at the surface, by using one or more processors.

In another embodiment, antenna assemblies 413 and 415 may be configured to transmit EM waves into the formation 13, while antenna assembly 411 may be configured to receive EM waves (e.g. R-T-T). As a non-limiting example, antenna assembly 413 may be configured as a transmitter, while antenna assemblies 411 and 415 may be configured as receivers (e.g. R-T-R). As another example, antenna assemblies 411 and 415 may be configured as transmitters, while antenna assembly 413 may be configured as a receiver (e.g. T-R-T).

To compensate for the effect of internal electrical mismatch between the transmitter and the receiver, four or more antenna assemblies may be disposed on the pads 403. Other embodiments may include fewer than four antenna assemblies, including a single antenna assembly.

FIG. 4B shows pad 403′ having four antenna assemblies according to embodiments of the present disclosure. Antenna assemblies 411, 413, 415, and 417 are disposed on pad 403′. These antenna assemblies may be positioned symmetrically on pad 403′. In one embodiment, antenna assembly 411, 413, 415, and 417 are spaced equidistance apart from each other (e.g. S1, S2, and S3 may be the same length). In another embodiment, antenna spacings S1 and S3 may not have the same length as spacing S2, but spacing S1 may have the same length as spacing S3. The transmitter-receiver configuration may alternate so that antenna assemblies 411 and 415 are configured to transmit EM waves and antenna assemblies 413 and 417 are configured to receive EM waves (e.g. T-R-T-R). In another embodiment, antenna assemblies 411 and 415 may be configured to receive EM waves; and antenna assemblies 413 and 417 may be configured to transmit EM waves (e.g. R-T-R-T). As another example, the inner antenna assemblies may be configured as receivers, while the outer antenna assemblies may be configured as transmitters. For example, antenna assemblies 413 and 415 may be configured to receive EM waves, and antenna assemblies 411 and 417 may be configured to transmit EM waves (e.g. T-R-R-T). Alternatively, the outer antenna assemblies may be configured as receivers, while the inner antenna assemblies may be configured as transmitters (e.g. R-T-T-R).

In other embodiments, the pads 403 may include antenna assemblies 411, 413, 415 that are only configured to transmit EM waves (e.g. T-T-T). The receiver antenna assembly may be disposed on (a) the surface, (b) another dielectric tool 10 conveyed in the same borehole, (c) another dielectric tool 10 conveyed in another borehole, or (d) the borehole itself. In other embodiments, the pads 403 may include a plurality of antenna assemblies configured to transmit EM waves and a plurality of antenna assemblies configured to receive EM waves. As another embodiment, pads 403 may include a plurality of antenna assemblies configured to transmit EM waves and at least one antenna assembly configured to receive EM waves. Alternatively, pads 403 may include at least one antenna assembly configured to transmit EM waves and a plurality of antenna assemblies configured to receive EM waves.

The dielectric tool 10 may include other sensors. For example, orientation sensors (not shown) may provide an indication of the orientation of the dielectric tool 10. In addition, accelerometers may be used downhole to provide other measurements indicative of the depth of the dielectric tool 10. The orientation sensors may include accelerometers, magnetometers or gyroscopes. Depth may also be estimated from a gyro output on the dielectric tool 10. Temperature sensors and pressure sensors may be disposed on dielectric tool 10.

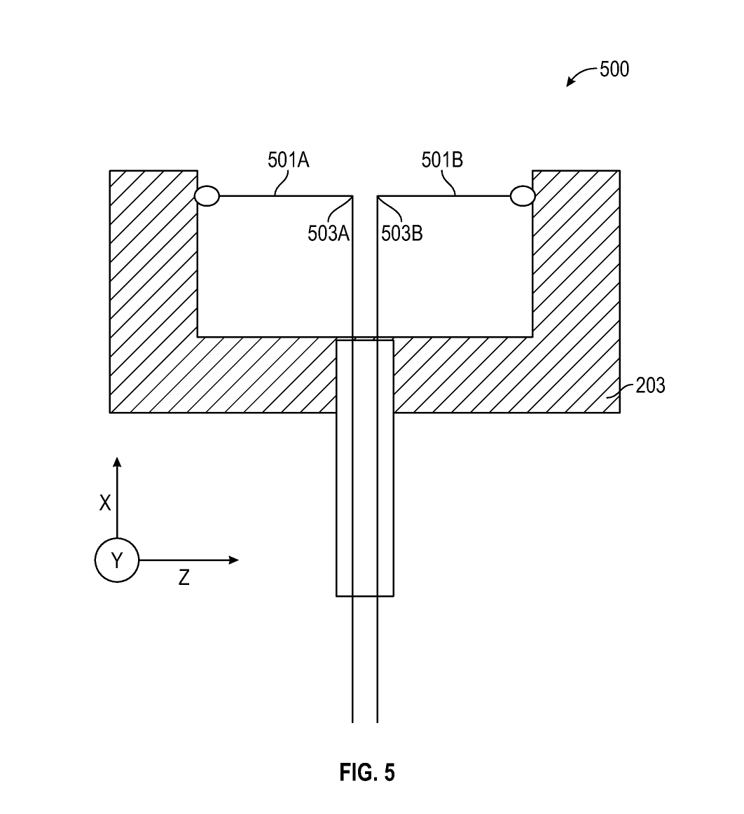

FIG. 5 shows a cross-sectional view of an antenna assembly 500 in accordance with embodiments of the present disclosure. This cross-section is representative of the antenna assembly having a magnetic moment parallel to the y-axis, where the y-axis is orthogonal to the X-Z plane depicted by the reference axes. In other embodiments, antenna assembly 500 may include magnetic moment orientations parallel to the x-axis, y-axis, and z-axis to provide a tri-axial antenna assembly (x-axis and z-axis elements are not shown). For example, antenna assembly 500 may include at least two other pairs of conducting arms that are orthogonal to those (501A, 501B) depicted in FIG. 5 to provide magnetic moments parallel to the x-axis and the z-axis. This tri-axial antenna configuration allows the antenna assembly to estimate anisotropic properties of the earth formation 13. Antenna drivers (not shown) may drive the antenna assembly sequentially along each axial orientation, but it may also be configured to drive each axial orientation simultaneously.

Antenna assembly 500 includes at least two antenna feeds 503A, 503B. These feeds 503A, 503B provide electrical communication to conducting arms 501A, 501B and the power source of the dielectric tool (not shown). Conducting arms 501A, 501B are disposed inside cavity 203, which is defined in the body of pad 403 (not shown). This cavity 203 may comprise a conductive material, a functionally gradient material, or a layered material comprising layers of functionally gradient materials and conductive materials. A functionally gradient material may include at least in part a dielectric material, a ferromagnetic material, or both of these materials. As non-limiting examples, cavity 203 may be defined by a cube, cuboid, or cylinder and filled with a non-conducting material to discourage movement of the radiating elements of the antenna.

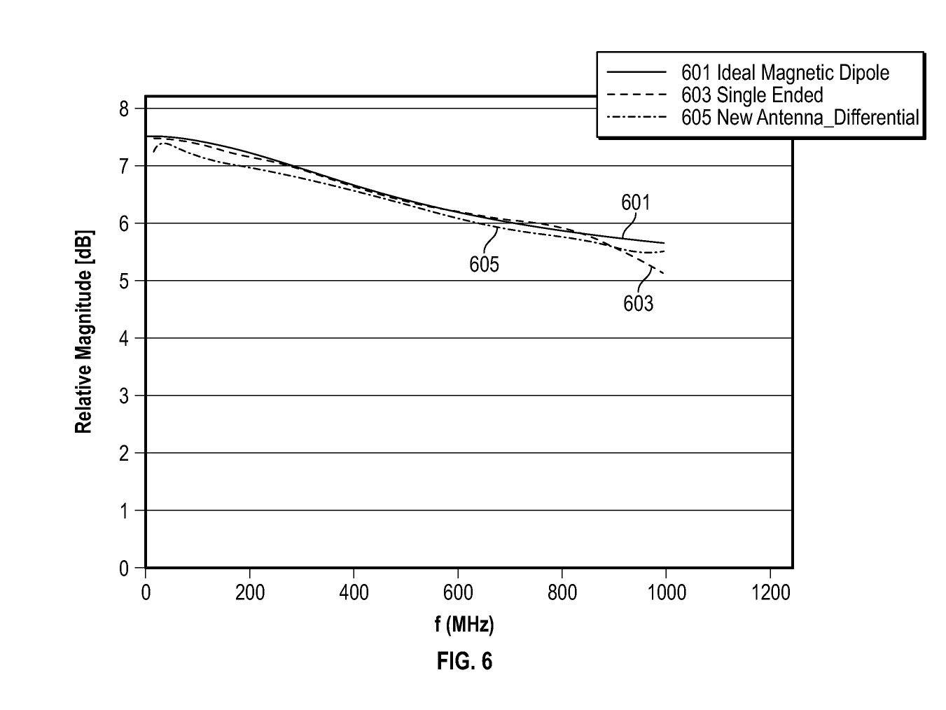

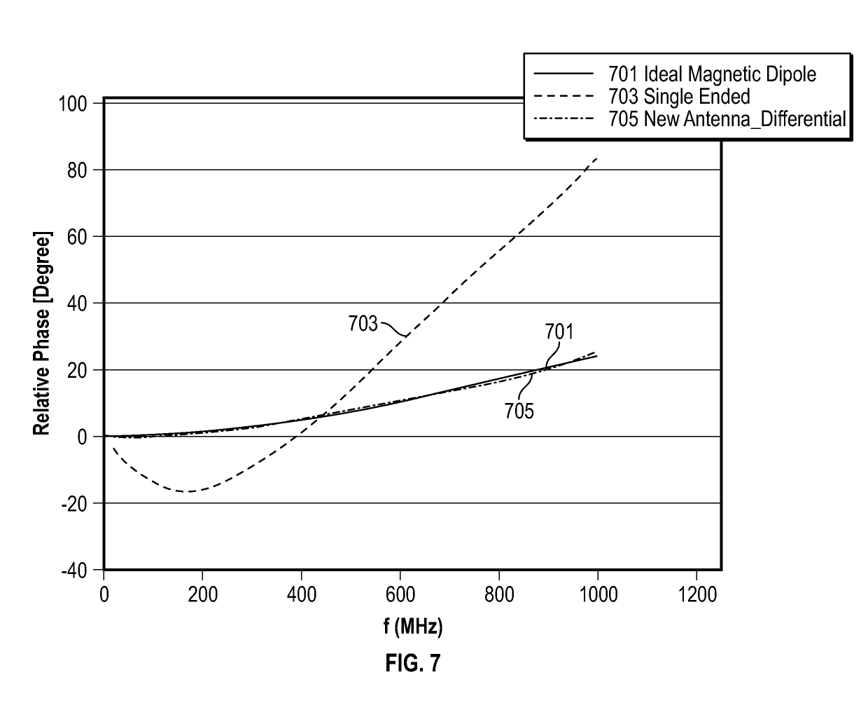

FIGS. 6 and 7 illustrate antenna performance parameters (e.g. relative magnitude and relative phase) of antenna assembly 500 in accordance with embodiments of the present disclosure. FIG. 6 shows a chart of the relative magnitude versus frequency for antenna assembly 500. This figure compares the relative magnitude 605 between two spaced receivers depicted in FIG. 4B to the relative magnitude 601 of an ideal magnetic dipole and the relative magnitude 603 of a single-ended antenna covering the frequency range of about 1 MHz to about 1 GHz. FIG. 7 shows a chart of the relative phase versus frequency for antenna assembly 500. This figure compares the relative phase 705 between two spaced receivers depicted in FIG. 4B to the relative phase 701 of an ideal magnetic dipole and the relative phase 703 of a single-ended antenna covering the frequency range of about 1 MHz to about 1 GHz.

FIGS. 6 and 7 demonstrate that the phase and magnitude response from about 1 MHz to about 1 GHz of antenna assembly 500 approximates the response of an ideal magnetic dipole. These figures confirm that antenna assembly 500 has performance characteristics that are substantially similar to an ideal magnetic dipole.

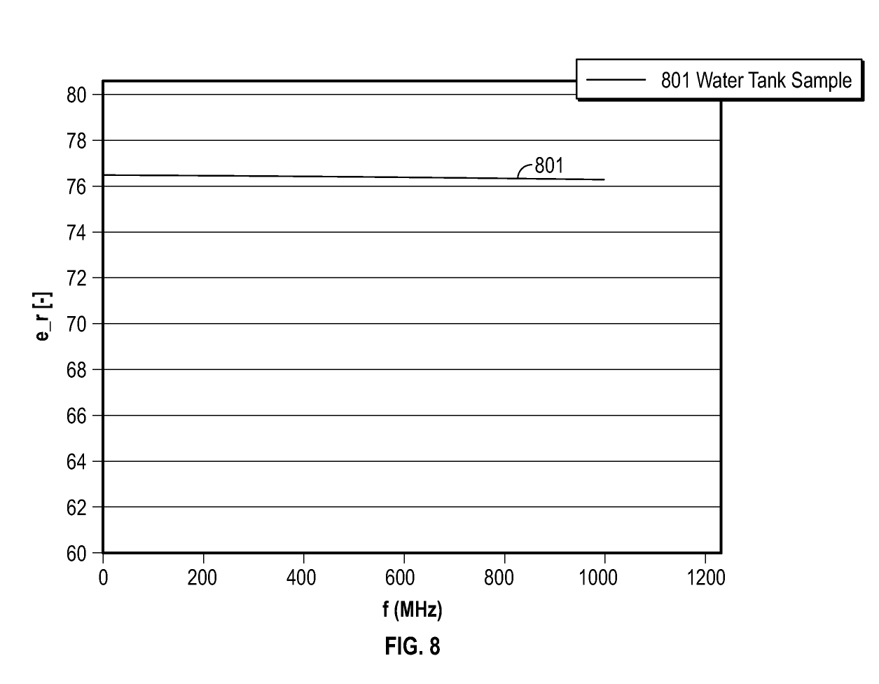

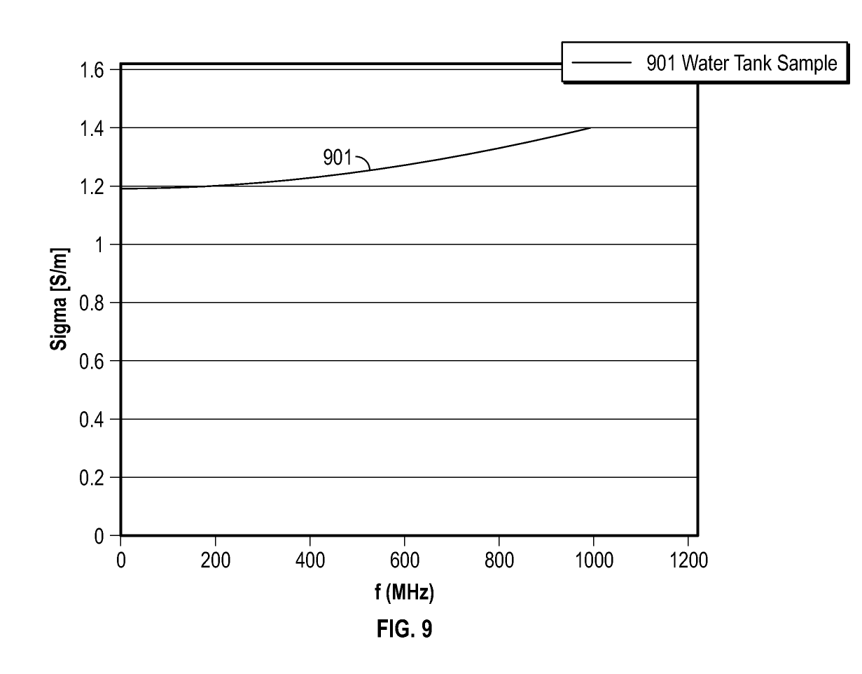

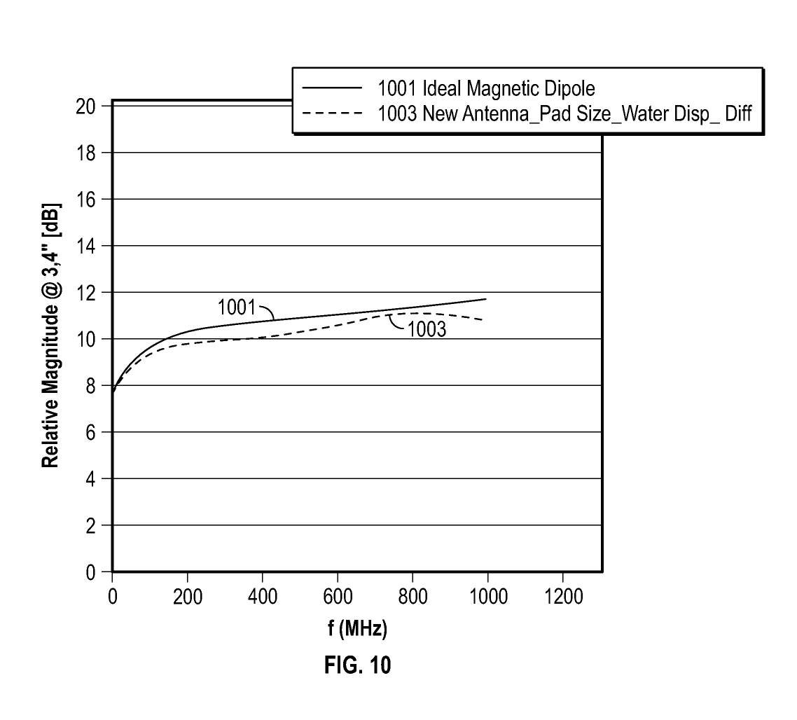

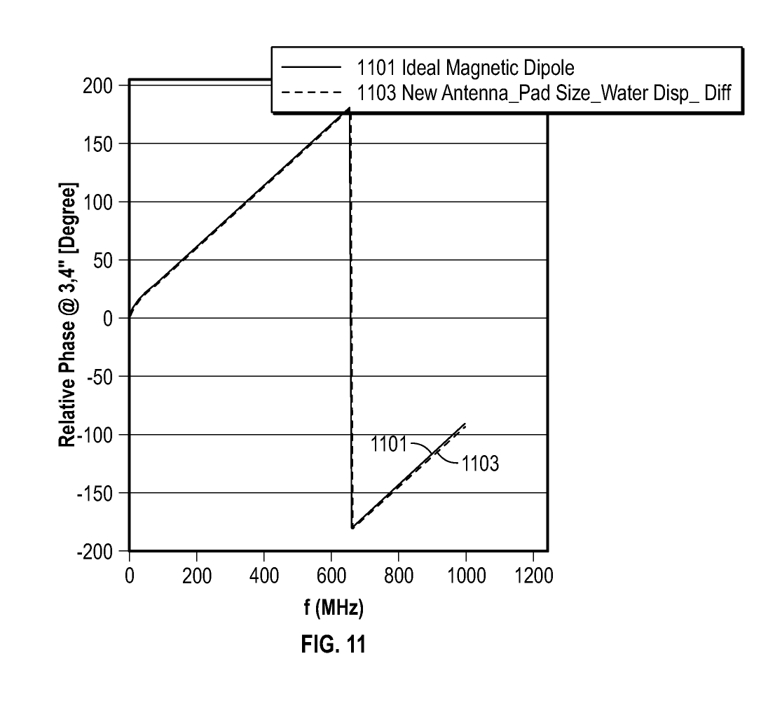

FIGS. 8 and 9 illustrate electrical properties of the water sample used to obtain the antenna performance parameters depicted in FIGS. 10 and 11. While antenna assembly 500 was immersed in a water sample, its performance was calculated over a frequency range of about 1 MHz to about 1 GHz to provide the performance parameters depicted in FIGS. 10 and 11. FIG. 8 shows a chart of the relative permittivity of the water sample versus frequency used in this performance test. FIG. 9 shows a chart of the conductivity of the water sample versus frequency used in this performance test. The conductivity of water was between about 1.4 S/m and 1.2 S/m for frequencies between 1 MHz and about 1 GHz.

FIGS. 10 and 11 illustrate the antenna performance parameters of antenna assembly 500 determined between two spaced receivers as depicted in FIG. 4B, while this antenna assembly was immersed in the water sample. FIG. 10 shows a chart of the relative magnitude versus frequency between two receivers depicted in FIG. 4B for antenna assembly 500. This figure compares the relative magnitude 1003 between two spaced receivers shown in FIG. 4B to the relative magnitude 1001 of the ideal magnetic dipole when these were immersed in the water sample. FIG. 11 shows a chart of the relative phase versus frequency for antenna assembly 500. This figure compares the relative phase 1103 between two spaced receivers shown on FIG. 4B to the relative phase 1101 of the ideal magnetic dipole when these were immersed in the water sample. In FIGS. 10 and 11, the actual size of the pad 403′ was taken into account rather than assuming it represented a perfect ground plane having an infinite size. This assumption that the pad represented a perfect ground plane was made in obtaining the performance parameters depicted in FIGS. 6 and 7. FIGS. 10 and 11 demonstrate that the phase and magnitude response from about 1 MHz to about 1 GHz of antenna assembly 500 approximates the response of an ideal magnetic dipole.

FIGS. 12-15 depict various logarithmic periodic (log-periodic) antenna shapes in accordance with embodiments of the present disclosure. FIG. 12 shows a cross-sectional view of antenna assembly 1200 in accordance with embodiments of the present disclosure. This cross-section is representative of antenna assembly 1200 having a magnetic moment oriented along the y-axis. In other embodiments, antenna assembly 1200 may include other radiating elements that provide a tri-axial antenna assembly (not shown). As a non-limiting example, the radiating elements of antenna assembly 1200 may include conducting arms 1201A, 1201B; conducting elements 1205A, 1205B; the pad face operating as a ground plane; and the cavity 203. Antenna assembly 1200 includes at least two feeds 1203A, 1203B to the radiating elements (e.g. 1201A, 1201B, 203) of the antenna assembly. These feeds 1203A, 1203B provide electrical communication to conducting arms 1201A, 1201B and the antenna drivers 1207 of the dielectric logging tool. Antenna assembly 1200 includes a cavity 203 and conducting arms 1201A, 1201B are electrically connected to the cavity 203, which may be defined by pad 403 or the tool body 400.

Antenna assembly 1200 may be configured as a logarithmic periodic antenna (log-periodic antenna). A log-periodic antenna is an antenna having a structural geometry such that its impedance and radiation characteristics repeat periodically as the logarithm of frequency. As a consequence, a log-periodic antenna operates across a wide bandwidth of frequencies. As a non-limiting example, antenna assembly 1200 may be configured to operate in a frequency range from about 2 MHz to about 1 GHz, having a ratio bandwidth of about 500:1. A ratio bandwidth is defined as a ratio of the upper to lower frequencies:

$${B}_{r} = \frac{{f}_{U}}{{f}_{L}}$$

A wide bandwidth may include bandwidth ratios about or greater than 5:1. Other embodiments of the present disclosure may have a wide bandwidth or a bandwidth ratio of about or less than 500:1.

Each conducting arm 1201A, 1201B may have conducting elements 1205A, 1205B spaced logarithmically apart from each other on its conducting arm. Conducting elements 1205A, 1205B may electrically connect to cavity 203 to increase the radiation surface or current distribution of antenna assembly 1200.

Antenna drivers 1207 may comprise power drivers configured to enforce symmetric current on both feeds of the transmitter antenna causing a point of symmetry of the current to align with an axis of symmetry of the transmitter antenna. These antenna drivers may include a first power driver and a second power driver in electrical communication with an excitation source (not shown). The antenna drivers 1207 may be in electrical communication with the antenna assembly 1200 via a transmission line, coaxial cable, twisted pair, or other electrical transmission cables. Each power driver may apply an output current to antenna assembly 1200 via feeds 1203A, 1203B. The power drivers may have balanced differential outputs in electrical communication with antenna assembly 1200. As described herein, a balanced differential output refers to the output currents having a balanced phase shift to enforce a symmetric current across the extent of the radiating elements of the antenna.

The first power driver may be configured to apply an electrical signal to the antenna assembly across the same bandwidth of the antenna via feed 1203A. For example, the radiating elements of antenna assembly 1000 may be configured to operate in a frequency range from about 2 MHz to about 1 GHz. Thus, the power drivers may be configured to operate across this same frequency range.

The second power driver may be configured to apply a modulated phase of the output current of the first power driver via feed 1203B. That is, the second power driver may apply an electric current to antenna assembly 1200 such that the second power driver's output current has a shifted phase from the output current of the first power driver. In one embodiment, the second power driver may apply a current to the antenna assembly that has substantially 180 degree phase shift from the output current of the first power driver. The output current of the first power driver and the modulated current applied to the antenna assembly may enforce symmetric current on both feeds of the transmitter antenna causing a point of symmetry of the current to align with an axis of symmetry of the transmitter antenna's geometry (or dimensions). In other embodiments, the second power driver may modulate the amplitude of this phase-shifted current. The first power driver may be in electrical communication with feed 1203A; and the second power driver may be in electrical communication with feed 1203B.

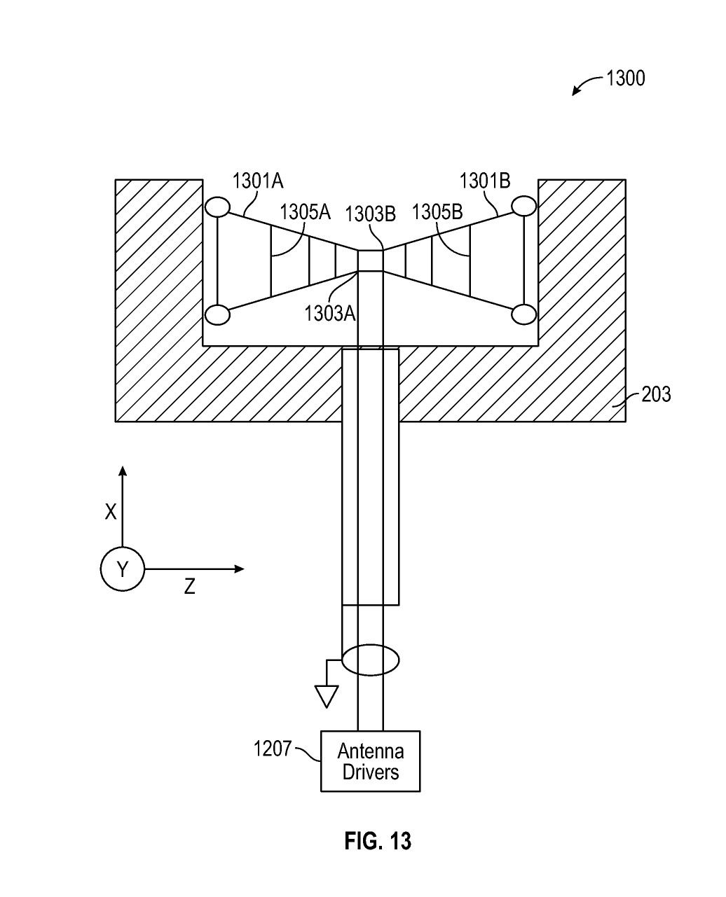

FIG. 13 shows a cross-sectional view of an antenna assembly 1300 in accordance with embodiments of the present disclosure. This cross-section is representative of antenna assembly 1300 having a magnetic moment oriented along the y-axis. In other embodiments, antenna assembly 1300 may include a tri-axial antenna assembly (not shown). Antenna assembly 1300 includes at least two feeds 1303A, 1303B to the radiating elements of the antenna assembly. These feeds 1303A, 1303B provide electrical communication to conducting arms 1301A, 1301B and the antenna drivers 1207. Antenna assembly 1300 includes a cavity 203 but conducting arms 1301A, 1301B are not electrically connected to the cavity 203, which may be defined by pad 403 or the tool body. Conducting arms 1301A, 1301B may define a bow-tie shape inside cavity 203.

Antenna assembly 1300 may be configured as a log-periodic antenna. Each conducting arm 1301A, 1301B may have conducting elements 1305A, 1305B spaced logarithmically apart from other conducting elements on the respective conducting arm. This allows the antenna assembly 1300 to operate across a wide bandwidth, e.g. a bandwidth ratio of about 500:1.

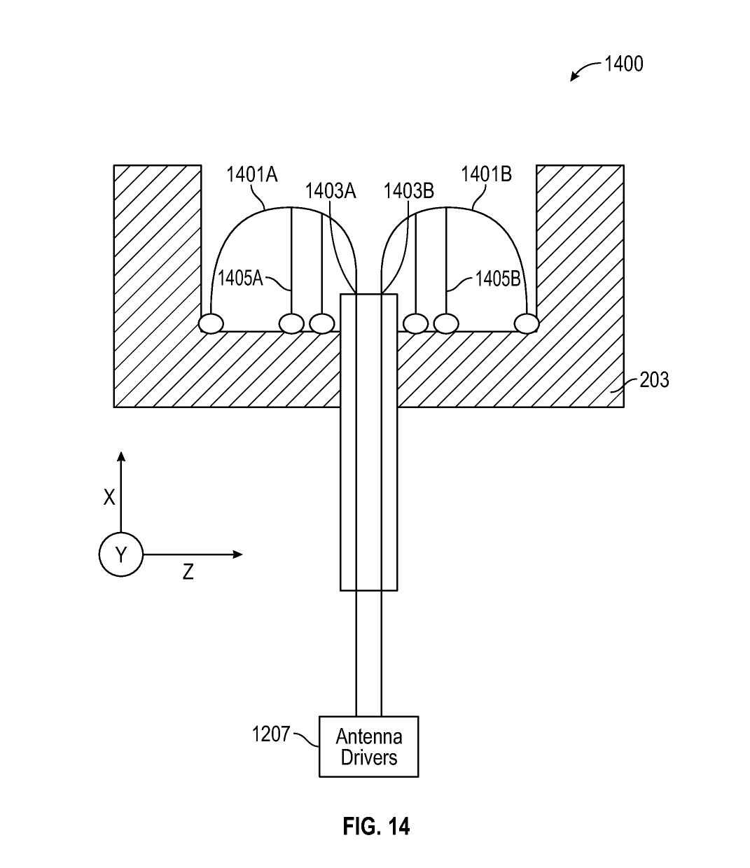

FIG. 14 shows a cross-sectional view of an antenna assembly 1400 in accordance with embodiments of the present disclosure. This cross-section is representative of antenna assembly 1400 having a magnetic moment oriented along the y-axis. In other embodiments, antenna assembly 1400 may include a tri-axial antenna assembly (not shown). Antenna assembly 1400 includes at least two feeds 1403A, 1403B to the radiating elements of the antenna assembly. These feeds 1403A, 1403B provide electrical communication to conducting arms 1401A, 1401B and the antenna drivers 1207. Antenna assembly 1400 includes a cavity 203 and conducting arms 1401A, 1401B are electrically connected to the cavity 203, which may be defined by pad 403 or the tool body. Conducting arms 1401A, 1401B may define a semi-circular shape over cavity 203.

Antenna assembly 1400 may be configured as a log-periodic antenna. Each conducting arm 1401A, 1401B may have conducting elements 1405A, 1405B spaced logarithmically apart from other conducting elements on the respective conducting arm 1401A or 1401B. This allows the antenna assembly 1400 to be tuned across a wide bandwidth. Conducting elements 1405A, 1405B may electrically connect to cavity 203 to increase the radiation surface of antenna assembly 1400.

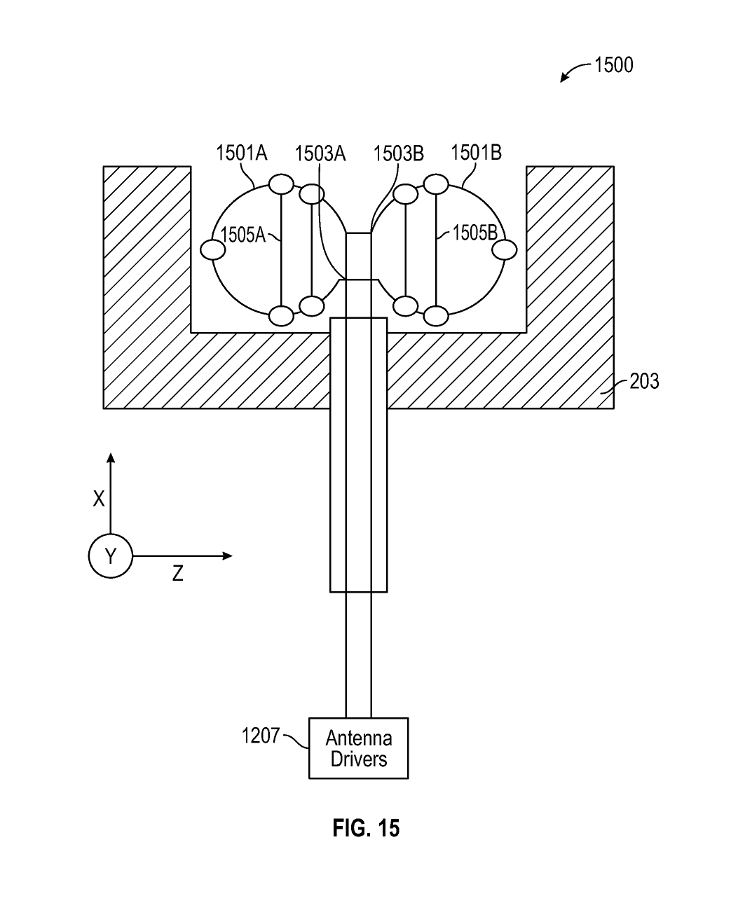

FIG. 15 shows a cross-sectional view of an antenna assembly 1500 in accordance with embodiments of the present disclosure. This cross-section is representative of antenna assembly 1500 having a magnetic moment oriented along the y-axis. In other embodiments, antenna assembly 1500 may include a tri-axial antenna assembly (not shown). Antenna assembly 1500 includes at least two feeds 1503A, 1503B to the radiating elements of the antenna assembly. These feeds 1503A, 1503B provide electrical communication to conducting arms 1501A, 1501B and the antenna drivers 1207. Antenna assembly 1500 includes a cavity 203 but conducting arms 1501A, 1501B are not electrically connected to the cavity 203, which may be defined by pad 403 or the tool body. As a non-limiting example, conducting arms 1501A, 1501B may define a circular shape or a closed curve having at least one axis of symmetry (e.g. an ellipse) inside cavity 203.

Antenna assembly 1500 may be configured as a log-periodic antenna. Each conducting arm 1501A, 1501B may have conducting elements 1505A, 1505B spaced logarithmically apart from other conducting elements on the respective conducting arm. This allows the antenna assembly 1500 to operate across a wide bandwidth.

Antenna assemblies 1200, 1300, 1400, and 1500 depict log-periodic antennas. Each conducting arm of the log-periodic antenna may comprise a plurality of conducting elements defined by a perimeter that is one of (a) triangular, (b) circular, (c) semi-circular, (d) elliptical, (e) semi-elliptical, (f) trapezoidal, (g) and quadrilateral. These are non-limiting shapes for the radiating elements of the antenna assembly in accordance with this disclosure. The antenna assemblies may incorporate other shapes for radiating elements to provide superior performance over a wide frequency band, e.g. approximating the performance of an ideal magnetic dipole. As a non-limiting example, antenna assembly 500, 1200, 1300, 1400, or 1500 may configure the thickness of the radiating elements (e.g. conducting arms 1201A, 1201B and conducting elements 1205A, 1205B) to vary the frequency response of the antenna. That is, as the diameter or thickness of the radiating elements (e.g. conducting arms 1201A, 1201B and conducting elements 1205A, 1205B) increases, the inductance of the antenna decreases, but the capacitance of the antenna increases, resulting in a modified frequency response. The radiating elements of these antenna assemblies may be used as either transmitter antennas or receiver antennas. The shape of the conducting arms and conducting elements may be identical between the transmitter and receiver antenna assemblies. In other embodiments, the shape of the conducting arms and conducting elements may be different between the transmitter and receiver antenna assemblies. For example, antenna assembly 1200 may be configured as a transmitter, while antenna assembly 1300 may be configured as a receiver with both being disposed on pad 403. As another example, the logarithmic spacing between the conducting elements may be different between the transmitter and receiver assemblies to enhance the frequency response of either antenna at different frequencies across their bandwidth. As another example, the transmitter may be configured to have a different frequency band than the receiver. In other embodiments, a tri-axial antenna may comprise one or more log-periodic antennas oriented along each axis. As used herein, a tri-axial antenna may be log-periodic with one or more orthogonal log-periodic antennas disposed in a cavity. For example, a log-periodic antenna may be oriented along the y-axis, while two loop antennas may be oriented along the z-axis and the x-axis according to the reference axes of FIG. 3B. As another example, two log periodic antennas may be oriented along the y-axis and the z-axis, while a loop antenna may be oriented along the x-axis according to the reference axes of FIG. 3B.

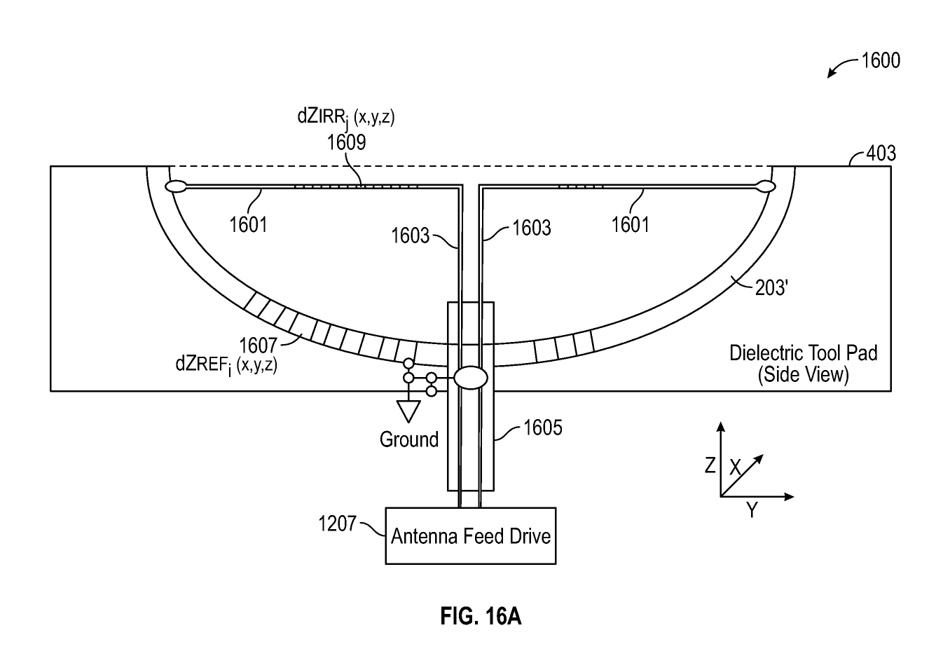

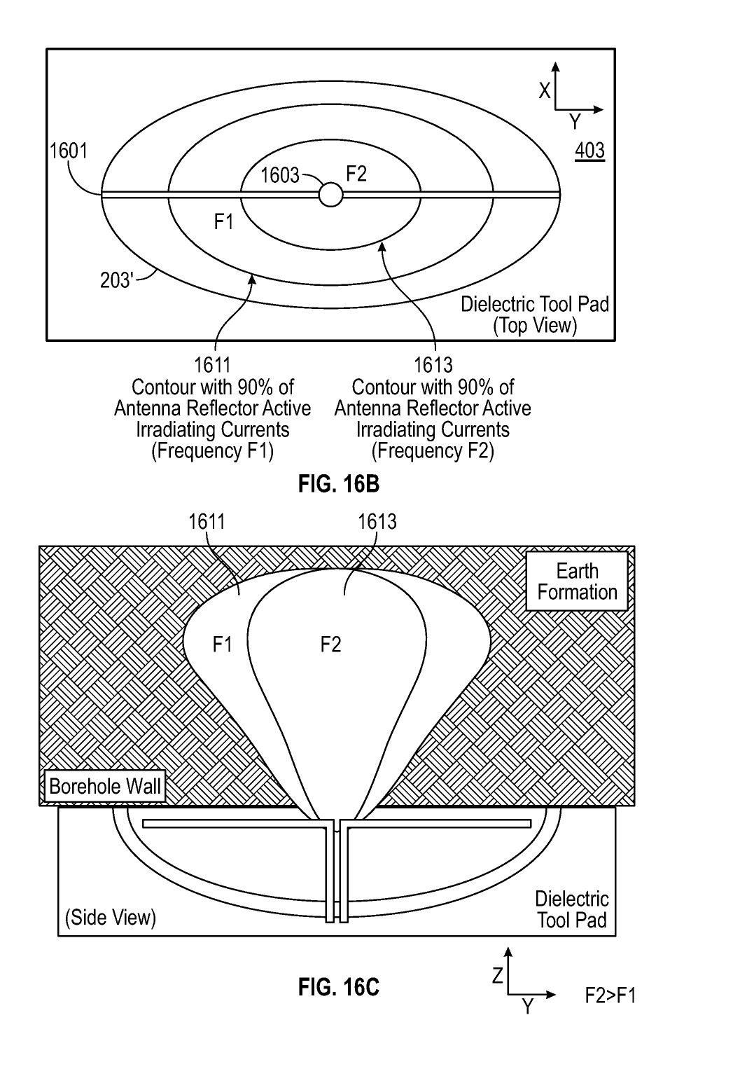

FIG. 16A shows a cross-sectional view of antenna assembly 1600 in accordance with embodiments of the present disclosure. Antenna assembly 1600 may include cavity 203′, which is a concave cavity or defined by a paraboloid of revolution. Antenna assembly 1600 may include a pair of conducting arms 1601. Antenna feeds 1603 provide electrical communication between conducting arms 1601 and antenna drivers (antenna feed drivers) 1207. The electrical transmission line or coaxial cable connecting antenna drivers 1207 to the antenna feeds 1603 may be surrounded by antenna feed shield 1605. This antenna feed shield 1605 may be configured as a ground reference in electrical communication with an isolated ground.

Antenna assembly 1600 may be approximated as finite and localized impedance elements (1609 and 1607) with varying impedance levels along the antenna radiating elements (uni-axial or tri-axial). Antenna cavity 203′ may be configured as an EM wave reflector and designed to obtain specific desired active radiating current distribution in the antenna reflector. The finite impedance elements may comprise a finite impedance element of the antenna reflector (1607) or a finite impedance element of the antenna radiating elements (1609). For example, the surface defining cavity 203′ may comprise at least one layer of a functionally gradient material on top of a metal material to vary the impedance characteristics of cavity 203′. The current distribution across the antenna reflector may be configured to enhance specific antenna performance (e.g. gain) to reach a design trade-off, such as vertical resolution, formation depth of investigation's signal penetration, and signal receiver measured levels. This enables optimum desired formation measurement and evaluation over the dielectric tool operating frequency range, target formation resistivity range, and borehole conditions. A distributed non-uniform impedance level at the finite elemental level in the radiating elements and/or reflector (cavity) surfaces may be configured using at least one of these methods: materials variations; materials mixing; a nano particles mix (e.g. same material or different geometry and sizes in the distribution of the mix); laser pattern micro-machining (e.g. cut-through openings on the material or surface); carved-out depression patterns in the surface (e.g. cut-through openings on the material or surface); structure constructed through 3D printing methods; and a combination of these techniques to configure the distributed non-uniform impedance level.

FIGS. 16B and 16C show radiation patterns 1611, 1613 of antenna assembly 1600 in accordance with embodiments of the present disclosure. FIG. 16B shows the contours of the radiation patterns 1611, 1613 from the top view of the dielectric tool pad 403. FIG. 16C shows the contours of radiation patterns 1611, 1613 from the side view of the dielectric tool pad 403. The radiation pattern 1613 depicts an approximate radiation pattern for when antenna assembly 1600 is energized at frequency F2, while radiation pattern 1611 is for frequency F1, where F2 is a higher frequency than F1. The finite elemental complex impedance distribution at each operating frequency of the radiating elements, the antenna cavity, or both may be configured to shape these energy spatial radiating patterns (e.g. front lobe or back lobe antenna gain distributions) and volumetric coupling to the target media (e.g. earth formation or borehole wall) proximate to the antenna. The reference axes of FIGS. 16A-C are independent of and not related to those depicted in FIGS. 2, 3A, 3B, 5, and 12-15; instead these reference axes are examples of the orientation of antennas according to embodiments of the present disclosure.

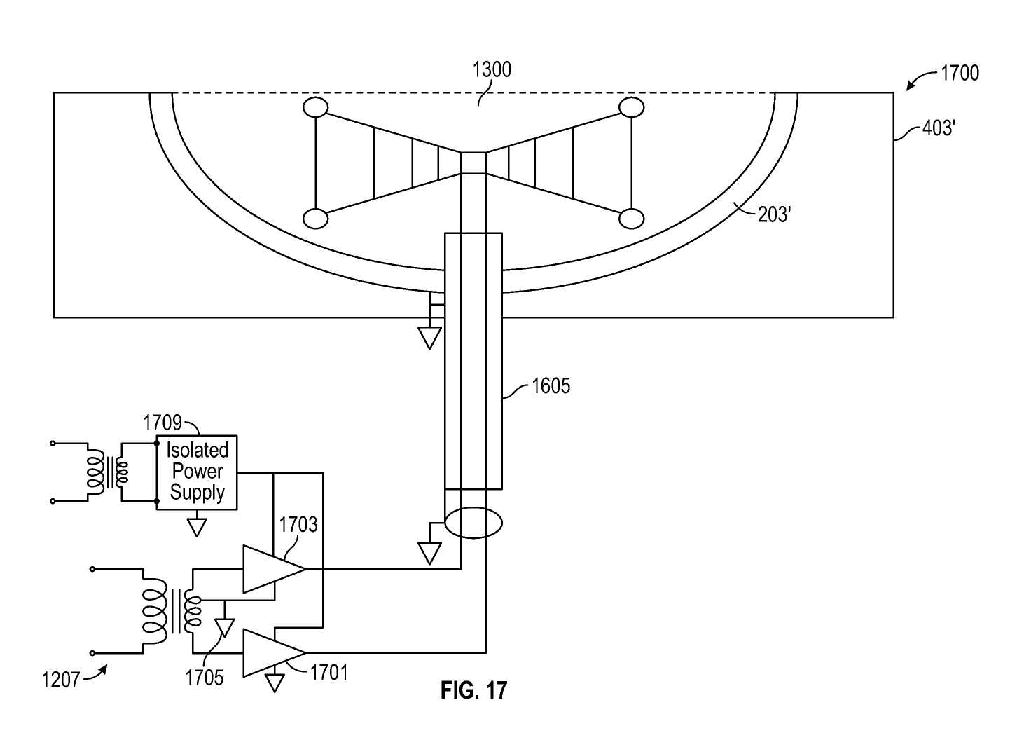

FIG. 17 shows a schematic of dielectric logging tool 1700 in accordance with embodiments of the present disclosure. Logging tool 1700 includes antenna assembly 1300 except that cavity 203′ is a concave cavity or defined by a paraboloid of revolution. Cavity 203′ may be configured as a parabolic EM wave reflector to enhance the performance (e.g. gain) of antenna assembly 1300. Antenna drivers 1207 include a first power driver 1701 and a second power driver 1703. Antenna drivers 1207 are in electrical communication with isolated ground 1705 and an excitation source 1709. Isolated ground 1705 may originate from the center tap of transformer 1607. Isolated ground 1705 is configured to provide a noise-free return ground independent of the electrical noise found on a common ground of a power supply disposed on the carrier (not shown). Antenna drivers 1207 may electrically float with respect to the pad 403′.

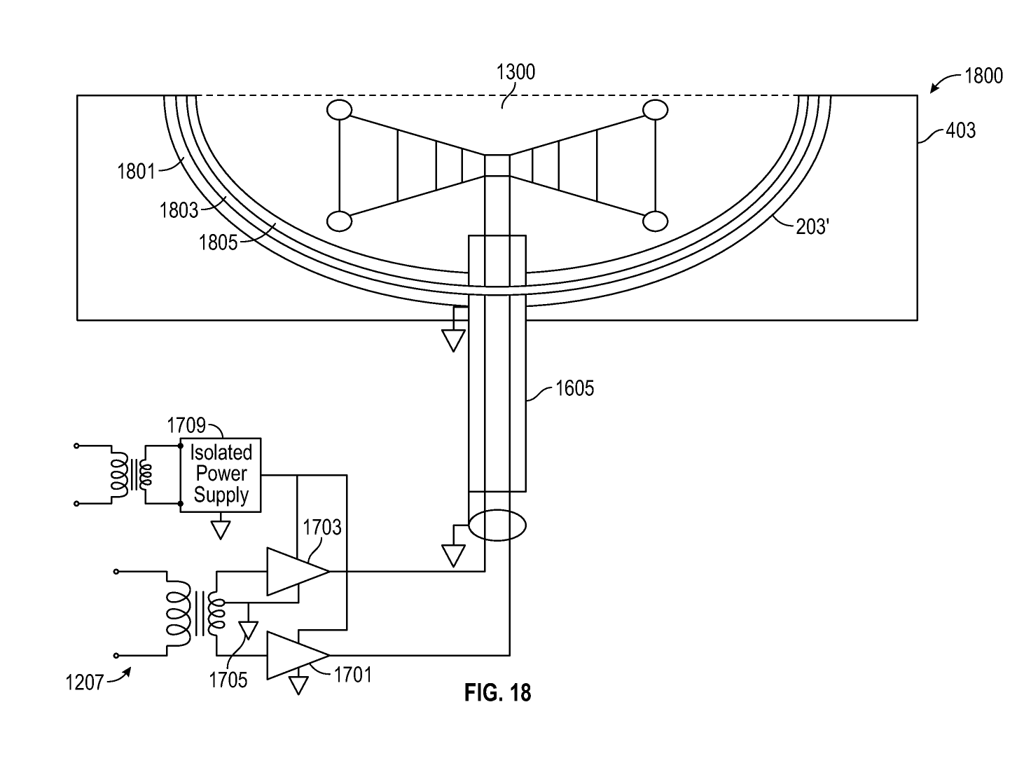

FIG. 18 shows a schematic of dielectric logging tool 1800 in accordance with embodiments of the present disclosure. Logging tool 1800 includes antenna assembly 1300 except cavity 203′ is a concave cavity or defined by a paraboloid of revolution. In one embodiment, cavity 203′ may be defined by a surface comprising a plurality of layers 1801, 1803, and 1805. The surface defining the cavity 203′ may comprise at least one layer of a functionally gradient material on top of a metal material. These layers 1801, 1803, 1805 may include a metal material or a functionally gradient material to enhance the EM wave focusing performance of cavity 203′. For example, the layers 1801, 1803, 1805 may be configured to approximate an impedance sufficient to enhance the gain of the EM wave radiating from antenna assembly 1300 to improve the vertical resolution, formation depth of investigation's signal penetration, or signal receiver measured levels. These layers 1801, 1803, 1805 represent a non-limiting example of embodiments of the present disclosure. The surface of antenna reflector (e.g. 203′) may include one or more layers that may be configured to approximate an impedance sufficient to enhance the gain of the EM wave radiating from the antenna.

Dielectric logging tools 1700 and 1800 may include at least one antenna assembly from the group consisting of antenna assembly 500, 1200, 1300, 1400, and 1500, except that cavity 203 may comprise a concave cavity or a cavity defined by a paraboloid of revolution. As a non-limiting example, logging tools 1700 and 1800 may incorporate other shapes for radiating elements, the antenna cavity, or both to provide superior performance over a wide frequency band, e.g. approximate the performance of an ideal magnetic dipole. In another embodiment, logging tools 1700 and 1800 may include at least one of these antenna assemblies having cavity 203 defined as depicted or described according to FIG. 5. As another example, the geometry of the radiating elements (e.g. loop, loops, bow-tie, loop with wire or ribbon, semi-circular, circular, etc.) and the geometry of the antenna cavity (e.g. cube, cuboid, cylindrical, concave, paraboloid of revolution, arbitrarily curved, etc.) may be configured to provide superior performance over wide frequency band, to shape the energy spatial radiating patterns and volumetric coupling to the target media, or to improve vertical resolution, formation depth of investigation's signal penetration, or signal receiver measured levels.

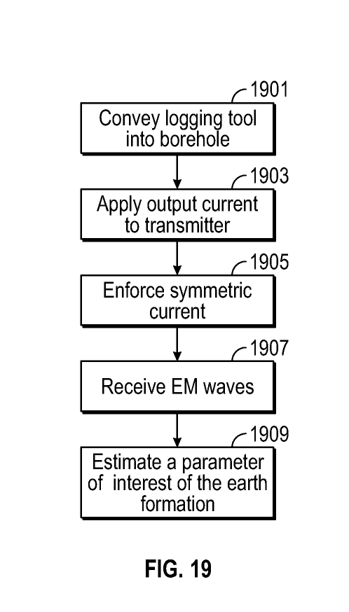

FIG. 19 shows a flow chart of method 1900 for estimating at least one parameter of interest according to embodiments of the present disclosure. In step 1901, logging tool 10 may be conveyed into a borehole intersecting the earth formation. In step 1903, an output current may be applied to the antenna assembly 1300 using first power driver 1703 via feed 1303A. The first power driver 1703 may be in electrical communication with at least one feed (e.g. 1303A) on antenna assembly 1300 and generate an output current at varying frequencies across the bandwidth of antenna assembly 1300. In step 1905, antenna drivers 1207 may enforce symmetric current on both feeds of the antenna assembly 1300 causing a point of symmetry of the current to align with the axis of symmetry of the transmitter antenna. The second power driver 1701 may apply a phase shifted-current to at least one feed of the antenna assembly (e.g. 1303B). In steps 1903 and 1905, antenna drivers 1207 may be configured to energize each axial radiating element (e.g. x-axis, y-axis, and z-axis radiating elements) sequentially; alternatively, each axial radiating element may be energized simultaneously. In step 1907, EM waves may be received by at least one receiver antenna, generating signals indicative of at least one parameter of interest. The signals received may be analyzed to estimate amplitude attenuation and phase difference from different frequencies at various distances along the borehole. As described herein, the parameter of interest may include at least one of (i) a water saturation of the formation, (ii) a water conductivity of the formation, (iii) a complex permittivity of the formation, (iv) a permittivity of rock matrix, (v) a complex permittivity of mudcake, (vi) a thickness of the mudcake, (vii) a texture of the rock, (viii) cementation exponent, (ix) saturation exponent, and (x) cation exchange capacity. In step 1909, a processor may be configured to estimate the parameter of interest using the received signals based on the attenuation and phase difference between the received signal and the transmitted signal, or between the received signals of at least two spaced receivers.

Implicit in the processing of the data is the use of a computer program implemented on a suitable non-transitory machine-readable medium (non-transitory computer-readable medium) that enables the processor to perform the control and processing. The term processor as used in this application is intended to include such devices as field programmable gate arrays (FPGAs). The non-transitory machine-readable medium may include ROMs, EPROMs, EAROMs, Flash Memories, and Optical disks. As noted above, the processing may be done downhole or at the surface, by using one or more processors. In addition, results of the processing, such as an image of a resistivity property or complex permittivity, can be stored on a suitable medium.

As used herein, by “symmetric current on both ends of antenna,” it is meant that the current at one end (e.g. an antenna feed) has a phase shift of 180 degrees with respect to the other end (e.g. another antenna feed). By “an ideal magnetic dipole,” it is meant the length of antenna is small in comparison to the wavelength of the electromagnetic wave and hence the behavior of the antenna can be approximated as a point source. By “a single-ended antenna,” this disclosure refers to a loop antenna fed from one side of its radiating extent and grounded to the cavity on the other side of its radiating extent as depicted in FIG. 2. The term “pad,” as used herein, refers to that part of a logging tool that is pressed firmly against the borehole wall and holds sensors (e.g. an antenna assembly according to embodiments of this disclosure) to measure the parameter of interest of the earth formation. The pad may be extended from the tool body on an arm (e.g. pad 403 of FIG. 4) or may be incorporated into the tool body (e.g. body 400 of FIG. 4). The term “functionally gradient material” refers to a material that comprises at least one of (a) a dielectric material, (b) a ferromagnetic material, (c) and a combination of a dielectric materials and ferromagnetic materials. The term “metal material” refers to a material that comprises at least in part a metal conductor. As described herein, “complex permittivity” refers to a permittivity having a real part, which is commonly called the dielectric constant, and an imaginary part, which is commonly called the dielectric loss factor or loss tangent. As described herein, the terms “cementation exponent” and “saturation exponent” refer to parameters of Archie's law including the exponent m and the exponent n, respectively. As described herein, a performance parameter (e.g. phase or magnitude) of an antenna (or antenna assembly) according to embodiments of the disclosure that approximates the performance of an ideal magnetic dipole is when the antenna's performance parameter (e.g. phase) is within about ±20 percent of the ideal magnetic dipole's corresponding performance parameter (e.g. phase). Performance parameters of an antenna, as used herein, may include phase, magnitude, directivity, gain, radiation efficiency, impedance, and radiation pattern. Cavity, as used herein, means a hollowed-out space of a body that holds an antenna (e.g. uni-axial, multi-axial antenna, or log-periodic antenna) in accordance with embodiments of the present disclosure. The cavity may be filled with a non-conducting material to discourage movement of the antenna or electrical disturbances. Cavity may be defined as a depression extending to at least a depth of 10 percent of a thickness of a tool body (e.g. body 400), or 25 percent of a thickness of a pad (e.g. pad 403), or the like.

As described herein, assumptions have been employed to estimate the performance parameters depicted in FIGS. 6, 7, 10 and 11. The performance parameters depicted in FIGS. 6 and 7 assume that antenna assembly 500 is over a perfect ground plane, extending infinitely along the z-axis. The perfect ground plane is an ideal ground plane in the sense that it is planar, infinite in extent, and perfectly conducting. The performance parameters depicted in FIGS. 10 and 11 take into account the size (or dimensions) of pad 403 by which antenna assembly 300 is defined. In other words, the charts depicted in FIGS. 10 and 11 do not assume that the pad 403 represents a perfect ground plane, but instead determines the relative phase and magnitude between two spaced receivers based on the size (or dimensions) of the pad.

While the foregoing disclosure is directed to specific embodiments of the disclosure, various modifications will be apparent to those skilled in the art. It is intended that all variations be embraced by the foregoing disclosure.

What is claimed is:

1. An apparatus for evaluating an earth formation, the apparatus comprising:
a carrier configured for conveyance in a borehole intersecting the earth formation;
a logging tool disposed on the carrier, the logging tool comprising:
a pad having at least one face configured to engage the borehole wall, the face comprising a surface defining a cavity,
at least one transmitter antenna disposed in the cavity of the face, the at least one transmitter antenna receiving an electrical signal from an excitation source, and
at least one power driver in electrical communication with the at least one transmitter antenna and configured to modulate a phase of output current of the at least one driver.

2. The apparatus of claim 1, wherein the electrical signals applied to the at least one transmitter antenna enforce symmetric current on both ends of the at least one transmitter antenna causing a point of symmetry of the current to align with an axis of geometric symmetry of the at least one transmitter antenna.

3. The apparatus of claim 1, wherein the at least one transmitter antenna includes at least one feed, and the power driver is in electrical communication with the at least one transmitter antenna through at least one feed.

4. The apparatus of claim 3, wherein the at least one transmitter antenna comprises a tri-axial antenna

5. The apparatus of claim 4, wherein the at least one transmitter antenna comprises a feed for each axis; each feed is in electrical communication with the at least one power driver; and the excitation source is in electrical communication with the at least one power driver.

6. The apparatus of claim 1, wherein the at least one transmitter antenna comprises a logarithmic periodic antenna.

7. The apparatus of claim 1, wherein the at least one transmitter antenna comprises a logarithmic periodic antenna having a bandwidth covering the frequency range from about 2 MHz to about 1 GHz.

8. The apparatus of claim 1, wherein the at least one transmitter antenna is disposed on the pad between the cavity and the earth formation, when and where the face is engaged with the borehole wall.

9. The apparatus of claim 1, wherein the cavity comprises a concave cavity configured to focus an electromagnetic wave into the earth formation.

10. The apparatus of claim 1, wherein the surface defining the cavity comprises at least one layer of a functionally gradient material on top of a metal material.

11. The apparatus of claim 1, wherein the functionally gradient material comprises at least one: (i) a dielectric material and (ii) a ferromagnetic material.

12. The apparatus of claim 1, wherein the at least one power driver has balanced differential outputs in electrical communication with the at least one transmitter antenna.

13. The apparatus of claim 1, wherein the at least one power driver electrically floats with respect to the pad.

14. The apparatus of claim 1, wherein the logging tool further comprises a second cavity on the pad with a receiver antenna disposed in the second cavity; the apparatus further comprising at least one processor configured to estimate a parameter of interest of the earth formation using signals received by the at least one receiver antenna.

15. The apparatus of claim 12, wherein the parameter of interest includes one of (i) a water content of the formation, (ii) a water saturation of the formation, (iii) a water conductivity of the formation, and (iv) a complex permittivity of the formation.

16. A method for evaluating an earth formation, the method comprising:
actively changing an impedance of at least one transmitter antenna disposed on a logging tool, using at least one power driver in electrical communication with the at least one transmitter antenna and configured to modulate a phase of an output current applied to the at least one transmitter antenna.

17. The method of claim 15, further comprising:
conveying the at least one transmitter in a borehole intersecting the earth formation, wherein the at least one transmitter antenna comprises a tri-axial antenna;
applying an output current to the at least one transmitter antenna using the at least one power driver;
enforcing symmetric current on both ends of the at least one transmitter causing a point of symmetry of the current to align with an axis of geometric symmetry of the at least one transmitter;
receiving signals using at least one receiver antenna; and
estimating a parameter of interest of the earth formation using the received signals.

18. The method of claim 16, wherein the parameter of interest includes one of (i) a water content of the formation, (ii) a water saturation of the formation, (iii) a water conductivity of the formation, and (iv) a complex permittivity of the formation.
